(19) United States
(12) Patent Application Publication
(10) Pub. No.: US 2026/0331742 A1
(43) Pub. Date: Oct. 22, 2026

(54) BEND-TYPE PHASE SHIFT CIRCUIT AND DIGITAL PHASE SHIFTER

(71) Applicant: Fujikura Ltd., Tokyo (JP)

(72) Inventor: Yusuke Uemichi, Sakura-shi (JP)

(73) Assignee: Fujikura Ltd., Tokyo (JP)

(21) Appl. No.: 19/644,197

(22) Filed: Apr. 10, 2026

(30) Foreign Application Priority Data
Apr. 16, 2025 (JP) 2025-067361

(51) Int. Cl. H01P 1/18; H01P 1/02

(52) U.S. Cl. CPC H01P 1/184; H01P 1/022

(57) ABSTRACT

A bend-type phase shift circuit 20a includes a signal line 41, an inner line 42, an outer line 43, a first ground conductor 44a electrically connected to one end of each of the inner line 42 and the outer line 43, a second ground conductor 44b electrically connected to the other end of the outer line 43 and not physically directly connected to the first ground conductor 44a, and an electronic switch 47a, 47b provided between the other end of the inner line 42 and the second ground conductor 44b. The signal line 41, the inner line 42, and the outer line 43 are bent. The bend-type phase shift circuit 20a is set to a low-delay mode in which the electronic switch 47a, 47b is in a closed state or a high-delay mode in which the electronic switch 47a, 47b is in an open state.

### BACKGROUND OF THE INVENTION

### Field of the Invention

The present invention relates to a bend-type phase shift circuit and a digital phase shifter.

Priority is claimed on Japanese Patent Application No. 2025-067361, filed Apr. 16, 2025, the content of which is incorporated herein by reference.

### Description of Related Art

In recent years, a digital control-type phase shifter (digital phase shifter) targeting high-frequency signals of microwaves, quasi-millimeter waves, millimeter waves, or the like has been developed. The digital phase shifter has a configuration in which a plurality of digital phase shift circuits, each of which is a unit, are cascade-connected. When the configuration of the digital phase shifter is a configuration in which the digital phase shift circuits are connected in a row, the length of the digital phase shifter increases.

Japanese Patent No. 7076658 discloses a digital phase shifter of which the length is decreased by adopting a configuration in which the digital phase shifter is bent by using a connection portion such as a bend-type line having a bent structure. Specifically, Japanese Patent No. 7076658 discloses a digital phase shifter having a bent configuration using a 180° bend-type connection portion and a digital phase shifter having a bent configuration using a 90° bend-type connection portion.

### SUMMARY OF THE INVENTION

In the digital phase shifter disclosed in Japanese Patent No. 7076658, when the number of digital phase shift circuits increases, the number of bending times increases, such that the length of the digital phase shifter is decreased as much as possible in many cases. For example, the digital phase shifter may have a zigzag shape (or a meandering shape) or a spiral shape. Here, the connection portion does not have a function as a phase shift circuit. Therefore, as the number of bending times increases, an occupied area of a portion that does not function as the phase shift circuit increases. As a result, the mounting area of the digital phase shifter increases.

The present invention is made in view of the above-described circumstances, and an object of the present invention is to provide a bend-type phase shift circuit and a digital phase shifter which can decrease the mounting area, compared to those in the related art.

In order to solve the above-described problem, a bend-type phase shift circuit (20, 20a, 20b) according to a first aspect of the present invention includes a signal line (41), an inner line (42) provided on at least one side of the signal line, an outer line (43) provided at a position farther from the signal line than the inner line, on at least one side of the signal line, a first ground conductor (44a) electrically connected to one end of each of the inner line and the outer line, a second ground conductor (44b) electrically connected to the other end of the outer line and not physically directly connected to the first ground conductor, and an electronic switch (47a, 47b) provided between the other end of the inner line and the second ground conductor. The signal line, the inner line, and the outer line are bent, and the bend-type phase shift circuit (20, 20a, 20b) is set to a low-delay mode in which the electronic switch is in a closed state or a high-delay mode in which the electronic switch is in an open state.

The bend-type phase shift circuit according to the first aspect of the present invention includes the signal line, the inner line, the outer line, the first ground conductor, the second ground conductor, and the electronic switch, has the same configuration as a digital phase shift circuit, and is set to the low-delay mode or the high-delay mode. In addition, the signal line, the inner line, and the outer line are bent. In this manner, in the bend-type phase shift circuit, a function of bending a signal path and a function as a phase shift circuit can be realized. Since this bend-type phase shift circuit is applied to a digital phase shifter, the mounting area can be decreased, compared to that in the related art.

As the bend-type phase shift circuit according to a second aspect of the present invention, in the bend-type phase shift circuit according to the first aspect of the present invention, the outer line includes one or two outer lines, the one end of at least one of the one or two outer lines may be electrically connected to the first ground conductor at a position separated from one end of the first ground conductor, and the other end of the at least one of the one or two outer lines may be electrically connected to the second ground conductor at a position separated from one end of the second ground conductor.

As the bend-type phase shift circuit according to a third aspect of the present invention, the bend-type phase shift circuit according to the first or second aspect of the present invention may include a capacitor (45) electrically connected between the signal line and at least one of the first ground conductor and the second ground conductor.

As the bend-type phase shift circuit according to a fourth aspect of the present invention, in the bend-type phase shift circuit according to the first or second aspect of the present invention, the outer line may include a first outer line (43a) disposed on an inner bent side with respect to the signal line and the inner line.

As the bend-type phase shift circuit according to a fifth aspect of the present invention, the bend-type phase shift circuit according to the fourth aspect of the present invention may include a third ground conductor (44c) located to overlap a center portion of the first outer line in a plan view and electrically connected to the center portion of the first outer line, and a capacitor (45) electrically connected between the center portion of the signal line and the third ground conductor.

As the bend-type phase shift circuit according to a sixth aspect of the present invention, in the bend-type phase shift circuit according to the fourth or fifth aspect of the present invention, the outer line may further include a second outer line (43b) disposed on an outer bent side with respect to the signal line and the inner line.

As the bend-type phase shift circuit according to a seventh aspect of the present invention, in the bend-type phase shift circuit according to the sixth aspect of the present invention, the first ground conductor and the second ground conductor may be strip-shaped conductors disposed such that extended lines therefrom intersect each other.

As the bend-type phase shift circuit according to an eighth aspect of the present invention, in the bend-type phase shift circuit according to the seventh aspect of the present invention, the signal line and the inner line may each include a first straight portion (L1) extending in a first direction intersecting the first ground conductor, a second straight portion (L2) extending in an oblique direction with respect to the first direction, and a third straight portion (L3) extending in a second direction intersecting the second ground conductor.

As the bend-type phase shift circuit according to a ninth aspect of the present invention, in the bend-type phase shift circuit according to the eighth aspect of the present invention, the first outer line may include a fourth straight portion (L4) extending in the first direction and a fifth straight portion (L5) extending in the second direction.

As the bend-type phase shift circuit according to a tenth aspect of the present invention, in the bend-type phase shift circuit according to the ninth aspect of the present invention, the first outer line may include a first oblique straight portion (L6) extending in the oblique direction, in addition to the fourth straight portion and the fifth straight portion, and the length of the first oblique straight portion may be longer than lengths of the fourth straight portion and the fifth straight portion.

As the bend-type phase shift circuit according to an eleventh aspect of the present invention, in the bend-type phase shift circuit according to any one of the eighth to tenth aspects of the present invention, the second outer line may include a second oblique straight portion (L7) extending in the oblique direction, and the length of the second oblique straight portion may be longer than lengths of the first straight portion and the second straight portion of each of the signal line and the inner line.

As the bend-type phase shift circuit according to a twelfth aspect of the present invention, in the bend-type phase shift circuit according to any one of the eighth to eleventh aspects of the present invention, the length of the second straight portion of the signal line may be longer than lengths of the first straight portion and the third straight portion of the signal line, and the length of the second straight portion of the inner line is longer than the lengths of the first straight portion and the third straight portion of the inner line.

A digital phase shifter (100, 200) according to a first aspect of the present invention includes a first digital phase shift circuit group (30) in which a plurality of digital phase shift circuits (10) are cascade-connected, a second digital phase shift circuit group (31) in which a plurality of digital phase shift circuits (10) are cascade-connected, the bend-type phase shift circuit (20, 20a, 20b) according to any one of the first to twelfth aspects, which is configured to electrically connect a first digital phase shift circuit (10-5) located at one end portion of the first digital phase shift circuit group, and a second digital phase shift circuit (10-7) located at one end portion of the second digital phase shift circuit group.

A digital phase shifter (100) according to a second aspect of the present invention includes a first digital phase shift circuit group (30) in which a plurality of digital phase shift circuits (10) are cascade-connected, a second digital phase shift circuit group (31) in which a plurality of digital phase shift circuits (10) are cascade-connected, a third digital phase shift circuit (10-6) electrically connected to a first digital phase shift circuit (10-5) located at one end portion of the first digital phase shift circuit group and a second digital phase shift circuit (10-7) located at one end portion of the second digital phase shift circuit group, a first bend-type phase shift circuit (20a) that is the bend-type phase shift circuit according to any one of the first to twelfth aspects, which is configured to connect the first digital phase shift circuit and the third digital phase shift circuit, and a second bend-type phase shift circuit (20b) that is the bend-type phase shift circuit according to any one of the first to twelfth aspects, which is configured to connect the second digital phase shift circuit and the third digital phase shift circuit.

As the digital phase shifter according to a third aspect of the present invention, in the digital phase shifter according to the first aspect of the present invention, each of the plurality of digital phase shift circuits forming the first digital phase shift circuit group and the plurality of digital phase shift circuits forming the second digital phase shift circuit group may be a circuit that includes a signal line (1), a pair of inner lines (2) provided on both sides of the signal line, a pair of outer lines (3) provided on outer sides of the pair of inner lines, a first ground conductor (4a) electrically connected to one end of each of the pair of inner lines and the pair of outer lines, a second ground conductor (4b) electrically connected to the other end of each of the pair of outer lines, and a pair of electronic switches (7a, 7b) respectively provided between the other ends of the pair of inner lines and the second ground conductor, and that are set to a low-delay mode in which the pair of electronic switches are in a closed state or a high-delay mode in which the pair of electronic switches are in an open state.

As the digital phase shifter according to a fourth aspect of the present invention, in the digital phase shifter according to the second aspect of the present invention, each of the plurality of digital phase shift circuits forming the first digital phase shift circuit group, the plurality of digital phase shift circuits forming the second digital phase shift circuit group, and the third digital phase shift circuit may be a circuit that includes a signal line (1), a pair of inner lines (2) provided on both sides of the signal line , a pair of outer lines (3) provided on outer sides of the pair of inner lines, a first ground conductor (4a) electrically connected to one end of each of the pair of inner lines and the pair of outer lines, a second ground conductor (4b) electrically connected to the other end of each of the pair of outer lines, and a pair of electronic switches (7a, 7b) respectively provided between the other ends of the pair of inner lines and the second ground conductor, and that are set to a low-delay mode in which the pair of electronic switches are in a closed state or a high-delay mode in which the pair of electronic switches are in an open state.

According to the present invention, there is an advantageous effect that the mounting area of the digital phase shifter can be decreased, compared to that in the related art.

### BRIEF DESCRIPTION OF THE DRAWINGS

FIG. 1 is a plan view showing the schematic configuration of a digital phase shifter according to a first embodiment of the present invention.

FIG. 2 is a perspective view showing the configuration of a digital phase shift circuit in the first embodiment of the present invention.

FIG. 3 is a diagram showing a high-delay mode of the digital phase shift circuit in the first embodiment of the present invention.

FIG. 4 is a diagram showing a low-delay mode of the digital phase shift circuit in the first embodiment of the present invention.

FIG. 5 is a plan view showing the configuration of a bend-type phase shift circuit according to the first embodiment of the present invention.

FIG. 6 is a plan view showing the configuration of a bend-type phase shift circuit according to a first modification example in the first embodiment of the present invention.

FIG. 7 is a plan view showing the configuration of a bend-type phase shift circuit according to a second modification example in the first embodiment of the present invention.

FIG. 8 is a plan view showing the configuration of a bend-type phase shift circuit according to a third modification example in the first embodiment of the present invention.

FIG. 9 is a plan view showing the configuration of a bend-type phase shift circuit according to a fourth modification example in the first embodiment of the present invention.

FIG. 10 is a plan view showing the configuration of a bend-type phase shift circuit according to a fifth modification example in the first embodiment of the present invention.

FIG. 11 is a plan view showing the configuration of a bend-type phase shift circuit according to a sixth modification example in the first embodiment of the present invention.

FIG. 12 is a plan view showing the configuration of a bend-type phase shift circuit according to a seventh modification example in the first embodiment of the present invention.

FIG. 13 is a plan view showing the configuration of a bend-type phase shift circuit according to an eighth modification example in the first embodiment of the present invention.

FIG. 14 is a plan view showing the configuration of a bend-type phase shift circuit according to a ninth modification example in the first embodiment of the present invention.

FIG. 15 is a plan view showing the configuration of a bend-type phase shift circuit according to a tenth modification example in the first embodiment of the present invention.

FIG. 16 is a plan view showing the schematic configuration of a digital phase shifter according to a second embodiment of the present invention.

### DETAILED DESCRIPTION OF THE INVENTION

Hereinafter, a bend-type phase shift circuit and a digital phase shifter according to an embodiment of the present invention are described in detail with reference to the drawings.

### First Embodiment

### Digital Phase Shifter

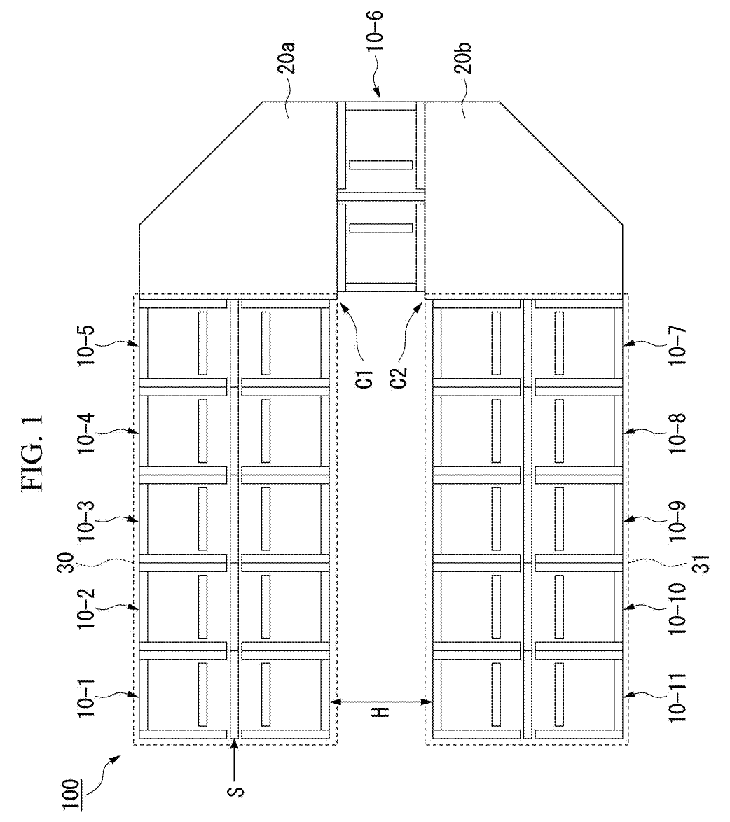

FIG. 1 is a plan view showing the schematic configuration of a digital phase shifter according to a first embodiment of the present invention. As shown in FIG. 1, a digital phase shifter 100 of the present embodiment includes a plurality of digital phase shift circuits 10 and a bend-type phase shift circuit 20a (first bend-type phase shift circuit) and a bend-type phase shift circuit 20b (second bend-type phase shift circuit). The digital phase shifter 100 shifts a phase of a signal S in a predetermined frequency band by using the plurality of digital phase shift circuits 10 and the bend-type phase shift circuits 20a and 20b that are cascade-connected. The signal S is a high-frequency signal having a frequency band of microwaves, quasi-millimeter waves, millimeter waves, or the like.

The plurality of digital phase shift circuits 10 are electrically cascade-connected. In an example shown in FIG. 1, eleven digital phase shift circuits 10 are electrically cascade-connected. However, the number of the digital phase shift circuits 10 is not limited to the example shown in FIG. 1, and may be three or more. In the example shown in FIG. 1, for convenience of description, the eleven digital phase shift circuits 10 that are electrically cascade-connected are denoted by digital phase shift circuits 10-1, 10-2, ..., and 10-11 in flowing order of the signal S. However, the flowing direction of the signal S may be reversed.

In the example shown in FIG. 1, the first to fifth digital phase shift circuits 10-1 to 10-5 that are cascade-connected form a first digital phase shift circuit group 30. In addition, the seventh to eleventh digital phase shift circuits 10-7 to 10-11 that are cascade-connected form a second digital phase shift circuit group 31. The sixth digital phase shift circuit 10-6 is located between the first digital phase shift circuit group 30 and the second digital phase shift circuit group 31, and is electrically connected to the first digital phase shift circuit group 30 and the second digital phase shift circuit group 31.

The bend-type phase shift circuits 20a and 20b have a shape of a 90° bend. The bend-type phase shift circuit 20a connects the digital phase shift circuit 10-5 (first digital phase shift circuit) located at one end portion of the first digital phase shift circuit group 30 and the other end portion of the digital phase shift circuit 10-6 (third digital phase shift circuit). The bend-type phase shift circuit 20b connects the digital phase shift circuit 10-7 (second digital phase shift circuit) located at one end portion of the second digital phase shift circuit group 31 and one end portion of the digital phase shift circuit 10-6 (third digital phase shift circuit). A specific configuration of the bend-type phase shift circuits 20a and 20b are described later.

The digital phase shifter 100 has a structure in which all of the plurality of digital phase shift circuits 10 are not aligned in a row, but a structure in which the digital phase shift circuits 10 are intermediately bent by the bend-type phase shift circuits 20a and 20b. For example, the first digital phase shift circuit group 30 and the second digital phase shift circuit group 31 are electrically connected by the bend-type phase shift circuits 20a and 20b. In this manner, the digital phase shifter 100 is bent. In this manner, the first digital phase shift circuit group 30 and the second digital phase shift circuit group 31 are disposed in parallel to be separated by a distance H.

### Digital Phase Shift Circuit

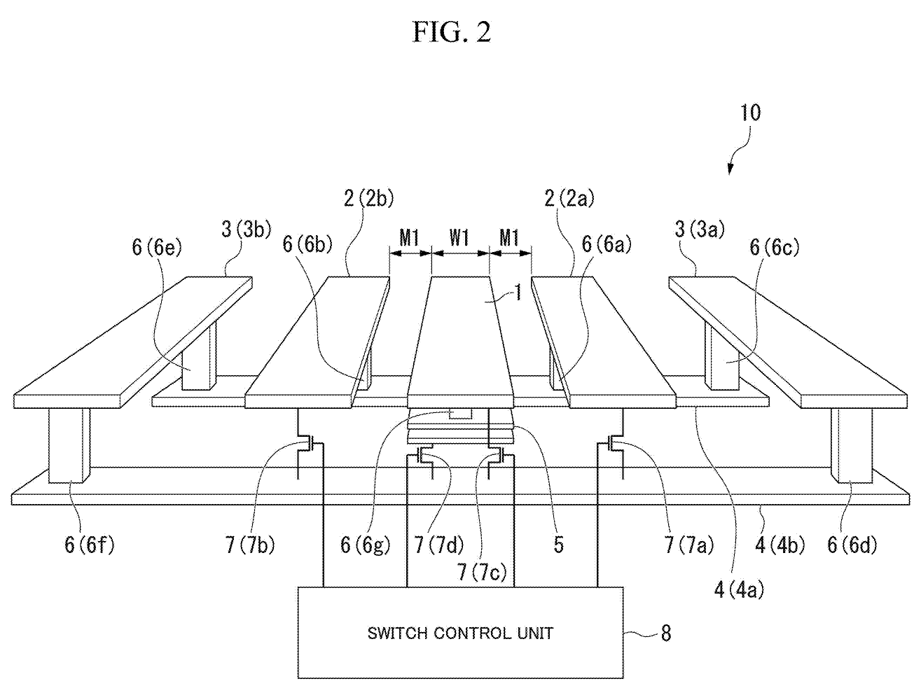

FIG. 2 is a perspective view showing a configuration of the digital phase shift circuit in the first embodiment of the present invention. As shown in FIG. 2, the digital phase shift circuit 10 includes a signal line 1, a pair of inner lines 2 (first inner line 2a and second inner line 2b), a pair of outer lines 3 (first outer line 3a and second outer line 3b), a pair of ground conductors 4 (first ground conductor 4a and second ground conductor 4b), a capacitor 5, a plurality of connection conductors 6, four electronic switches 7 (first electronic switch 7a, second electronic switch 7b, third electronic switch 7c, and fourth electronic switch 7d), and a switch control unit 8.

The signal line 1 is a linear strip-shaped conductor extending in a predetermined direction. That is, the signal line 1 is a long plate-shaped conductor having a constant width W1, a constant thickness, and a predetermined length. In an example shown in FIG. 2, the signal S flows from a front side toward a back side in the signal line 1.

The first inner line 2a is a linear strip-shaped conductor. That is, the first inner line 2a is a long plate-shaped conductor having a constant width, a constant thickness, and a predetermined length. The first inner line 2a extends in the same direction as an extending direction of the signal line 1. The first inner line 2a is provided in parallel with the signal line 1, and is separated to one side (right side in FIG. 2) of the signal line 1 by a predetermined distance M1.

The second inner line 2b is a linear strip-shaped conductor. That is, as in the first inner line 2a, the second inner line 2b is a long plate-shaped conductor having a constant width, a constant thickness, and a predetermined length. The second inner line 2b extends in the same direction as the extending direction of the signal line 1. The second inner line 2b is provided in parallel with the signal line 1, and is separated to the other side (left side in FIG. 2) of the signal line 1 by the predetermined distance M1.

The first outer line 3a is a linear strip-shaped conductor provided at a position farther from the signal line 1 than the first inner line 2a is, on one side of the signal line 1. The first outer line 3a is a long plate-shaped conductor having a constant width, a constant thickness, and a predetermined length. The first outer line 3a is provided in parallel with the signal line 1 to be separated at a predetermined distance from the signal line 1 in a state where the first inner line 2a is interposed therebetween. As in the first inner line 2a and the second inner line 2b, the first outer line 3a extends in the same direction as the extending direction of the signal line 1.

The second outer line 3b is a linear strip-shaped conductor provided at a position farther from the signal line 1 than the second inner line 2b is, on the other side of the signal line 1. As in the first outer line 3a, the second outer line 3b is a long plate-shaped conductor having a constant width, a constant thickness, and a predetermined length. The second outer line 3b is provided in parallel with the signal line 1 to be separated at a predetermined distance from the signal line 1 in a state where the second inner line 2b is interposed therebetween. As in the first inner line 2a and the second inner line 2b, the second outer line 3b extends in the same direction as the extending direction of the signal line 1.

The first ground conductor 4a is a linear strip-shaped conductor provided on one end side of each of the first inner line 2a, the second inner line 2b, the first outer line 3a, and the second outer line 3b. The first ground conductor 4a is electrically connected to one end of each of the first inner line 2a, the second inner line 2b, the first outer line 3a, and the second outer line 3b. The first ground conductor 4a is a long plate-shaped conductor having a constant width, a constant thickness, and a predetermined length.

The first ground conductor 4a is provided to be orthogonal to the first inner line 2a, the second inner line 2b, the first outer line 3a, and the second outer line 3b which extend in the same direction. The first ground conductor 4a is provided below to be separated at a predetermined distance from the first inner line 2a, the second inner line 2b, the first outer line 3a, and the second outer line 3b.

The first ground conductor 4a is set such that one end (right end in FIG. 2) thereof in a left-right direction is located at substantially the same position as a right side edge portion of the first outer line 3a in the left-right direction. In addition, the first ground conductor 4a is set such that the other end (left end in FIG. 2) thereof in the left-right direction is located at substantially the same position as a left side edge portion of the second outer line 3b in the left-right direction.

The second ground conductor 4b is a linear strip-shaped conductor provided on the other end side of each of the first inner line 2a, the second inner line 2b, the first outer line 3a, and the second outer line 3b. As in the first ground conductor 4a, the second ground conductor 4b is a long plate-shaped conductor having a constant width, a constant thickness, and a predetermined length.

The second ground conductor 4b is disposed in parallel with the first ground conductor 4a, and is provided to be orthogonal to the first inner line 2a, the second inner line 2b, the first outer line 3a, and the second outer line 3b, as in the first ground conductor 4a. The second ground conductor 4b is provided below to be separated at a predetermined distance from the first inner line 2a, the second inner line 2b, the first outer line 3a, and the second outer line 3b.

The second ground conductor 4b is set such that one end (right end in FIG. 2) thereof in the left-right direction is located at substantially the same position as the right side edge portion of the first outer line 3a in the left-right direction. In addition, the second ground conductor 4b is set such that the other end (left end in FIG. 2) thereof in the left-right direction is located at substantially the same position as the left side edge portion of the second outer line 3b in the left-right direction.

The capacitor 5 is provided between the other end of the signal line 1 and the second ground conductor 4b. For example, in the capacitor 5, an upper electrode thereof is electrically connected to the signal line 1, and a lower electrode thereof is electrically connected to the fourth electronic switch 7d. For example, the capacitor 5 is a thin film capacitor having a metal insulator metal (MIM) structure. The capacitor 5 has a capacitance Ca corresponding to a facing area of parallel flat plates. However, a comb tooth-type capacitor may be used for the capacitor 5 instead of a parallel flat plate capacitor.

The plurality of connection conductors 6 include at least connection conductors 6a to 6f. The connection conductor 6a is a conductor that electrically and mechanically connects one end of the first inner line 2a and the first ground conductor 4a. For example, the connection conductor 6a is a conductor extending in an up-down direction, in which one end (upper end) thereof is connected to a lower surface of the first inner line 2a, and the other end (lower end) thereof is connected to an upper surface of the first ground conductor 4a.

The connection conductor 6b is a conductor that electrically and mechanically connects one end of the second inner line 2b and the first ground conductor 4a. For example, as in the connection conductor 6a, the connection conductor 6b is a conductor extending in the up-down direction in which one end (upper end) thereof is connected to the lower surface of the second inner line 2b, and the other end (lower end) thereof is connected to the upper surface of the first ground conductor 4a.

The connection conductor 6c is a conductor that electrically and mechanically connects one end of the first outer line 3a and the first ground conductor 4a. For example, the connection conductor 6c is a conductor extending in the up-down direction in which one end (upper end) thereof is connected to the lower surface of the first outer line 3a at one end of the first outer line 3a, and the other end (lower end) thereof is connected to the upper surface of the first ground conductor 4a.

The connection conductor 6d is a conductor that electrically and mechanically connects the other end of the first outer line 3a and the second ground conductor 4b. For example, the connection conductor 6d is a conductor extending in the up-down direction in which one end (upper end) thereof is connected to the lower surface of the first outer line 3a at the other end of the first outer line 3a, and the other end (lower end) thereof is connected to the upper surface of the second ground conductor 4b.

The connection conductor 6e is a conductor that electrically and mechanically connects one end of the second outer line 3b and the first ground conductor 4a. For example, the connection conductor 6e is a conductor extending in the up-down direction in which one end (upper end) thereof is connected to the lower surface of the second outer line 3b at one end of the second outer line 3b, and the other end (lower end) thereof is connected to the upper surface of the first ground conductor 4a.

The connection conductor 6f is a conductor that electrically and mechanically connects the other end of the second outer line 3b and the second ground conductor 4b. For example, the connection conductor 6f is a conductor extending in the up-down direction in which one end (upper end) thereof is connected to the lower surface of the second outer line 3b at the other end of the second outer line 3b, and the other end (lower end) thereof is connected to the upper surface of the second ground conductor 4b.

The connection conductor 6g is a conductor that electrically and mechanically connects the other end of the signal line 1 and the upper electrode of the capacitor 5. For example, the connection conductor 6g is a conductor extending in the up-down direction in which one end (upper end) thereof is connected to the lower surface of the signal line 1 at the other end of the signal line 1, and the other end (lower end) thereof is connected to the upper electrode of the capacitor 5.

The first electronic switch 7a is located between the other end of the first inner line 2a and the second ground conductor 4b, and is electrically connected to the other end of the first inner line 2a and the second ground conductor 4b. For example, the first electronic switch 7a is a MOS-type FET (field effect transistor) in which a drain terminal thereof is electrically connected to the other end of the first inner line 2a, a source terminal thereof is electrically connected to the second ground conductor 4b, and a gate terminal thereof is electrically connected to the switch control unit 8.

The first electronic switch 7a is controlled to be in a closed state or in an open state, based on a gate signal input to the gate terminal of the first electronic switch 7a from the switch control unit 8. The closed state of the electronic switch is a state where the drain terminal and the source terminal thereof are respectively conductive. The open state of the electronic switch is a state where the drain terminal and the source terminal thereof are not respectively conductive, and the electrical connection of the electronic switch is cut off. Under the control of the switch control unit 8, the first electronic switch 7a is brought into a conductive state where the other end of the first inner line 2a and the second ground conductor 4b are electrically connected or into a cutoff state where the electrical connection therebetween is cut off.

The second electronic switch 7b is located between the other end of the second inner line 2b and the second ground conductor 4b, and is electrically connected to the other end of the second inner line 2b and the second ground conductor 4b. For example, the second electronic switch 7b is the MOS-type FET in which the drain terminal thereof is connected to the other end of the second inner line 2b, the source terminal thereof is connected to the second ground conductor 4b, and the gate terminal thereof is connected to the switch control unit 8.

The second electronic switch 7b is controlled to be in the closed state or in the open state, based on a gate signal input to the gate terminal of the second electronic switch 7b from the switch control unit 8. Under the control of the switch control unit 8, the second electronic switch 7b is brought into a conductive state where the other end of the second inner line 2b and the second ground conductor 4b are electrically connected or into a cutoff state where the electrical connection therebetween is cut off.

The third electronic switch 7c is located between the other end of the signal line 1 and the second ground conductor 4b, and is electrically connected to the other end of the signal line 1 and the second ground conductor 4b. For example, the third electronic switch 7c is the MOS-type FET in which the drain terminal thereof is connected to the other end of the signal line 1, the source terminal thereof is connected to the second ground conductor 4b, and the gate terminal thereof is connected to the switch control unit 8. In the example shown in FIG. 2, the third electronic switch 7c is provided on the other end side of the signal line 1, but the present invention is not limited thereto. The third electronic switch 7c may be provided on one end side of the signal line 1. The third electronic switch 7c may not be used unless necessary.

The third electronic switch 7c is controlled to be in the closed state or in the open state, based on a gate signal input to the gate terminal of the third electronic switch 7c from the switch control unit 8. Under the control of the switch control unit 8, the third electronic switch 7c is brought into a conductive state where the other end of the signal line 1 and the second ground conductor 4b are electrically connected or into a cutoff state where the electrical connection therebetween is cut off.

The fourth electronic switch 7d is connected in series to the capacitor 5 between the other end of the signal line 1 and the second ground conductor 4b. For example, the fourth electronic switch 7d is the MOS-type FET. In the example shown in FIG. 2, in the fourth electronic switch 7d, the drain terminal thereof is connected to the lower electrode of the capacitor 5, the source terminal thereof is connected to the second ground conductor 4b, and the gate terminal thereof is connected to the switch control unit 8.

The fourth electronic switch 7d is controlled to be in the closed state or in the open state, based on a gate signal input to the gate terminal of the fourth electronic switch 7d from the switch control unit 8. Under the control of the switch control unit 8, the fourth electronic switch 7d is brought into a conductive state where the lower electrode of the capacitor 5 and the second ground conductor 4b are electrically connected or into a cutoff state where the electrical connection therebetween is cut off.

The switch control unit 8 is a control circuit that controls the first electronic switch 7a, the second electronic switch 7b, the third electronic switch 7c, and the fourth electronic switch 7d, which are the plurality of electronic switches 7. For example, the switch control unit 8 includes four output ports. The switch control unit 8 outputs gate signals from the output ports thereof respectively, and supplies the gate signals to the gate terminals of the plurality of electronic switches 7 respectively. In this manner, the switch control unit 8 controls the plurality of electronic switches 7 to be in the open state or the closed state respectively.

FIG. 2 shows a perspective schematic view of the digital phase shift circuit 10 to easily understand a mechanical structure of the digital phase shift circuit 10, but the actual digital phase shift circuit 10 is formed as a multilayer structure by using a semiconductor manufacturing technology.

For example, in the digital phase shift circuit 10, the signal line 1, the first inner line 2a, the second inner line 2b, the first outer line 3a, and the second outer line 3b are formed in a first conductive layer. The first ground conductor 4a and the second ground conductor 4b are formed in a second conductive layer facing the first conductive layer with an insulating layer interposed therebetween. Components formed in the first conductive layer and components formed in the second conductive layer are connected to each other through via holes. The plurality of connection conductors 6 correspond to via holes embedded into the insulating layer.

Next, an operation of the digital phase shift circuit 10 in the present embodiment is described. Operation modes of the digital phase shift circuit 10 include a high-delay mode and a low-delay mode. The digital phase shift circuit 10 is operated in the high-delay mode or the low-delay mode.

### High-Delay Mode

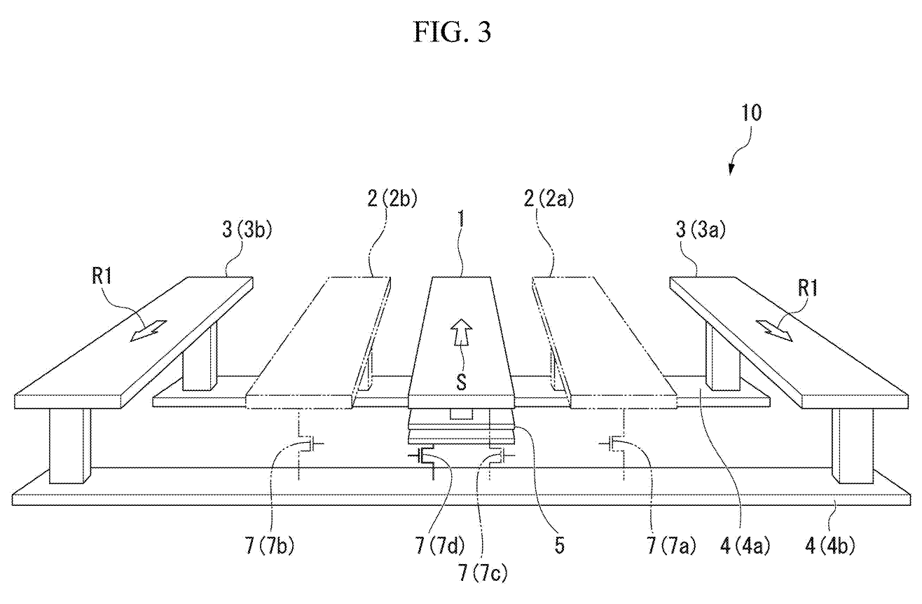

FIG. 3 is a diagram showing the high-delay mode of the digital phase shift circuit according to the first embodiment of the present invention. The high-delay mode is a mode in which a first passing phase is generated in the signal S. In the high-delay mode, as shown in FIG. 3, the first electronic switch 7a and the second electronic switch 7b are controlled to be in an open state, and the fourth electronic switch 7d is controlled to be in a closed state.

The first electronic switch 7a is controlled to be in the open state, thereby causing a state where the electrical connection between the other end of the first inner line 2a and the second ground conductor 4b is cut off. The second electronic switch 7b is controlled to be in the open state, thereby causing a state where the electrical connection between the other end of the second inner line 2b and the second ground conductor 4b is cut off. The fourth electronic switch 7d is controlled to be in the closed state, thereby causing a state where the other end of the signal line 1 is electrically connected to the second ground conductor 4b via the capacitor 5.

When the signal S propagates from an input end (the other end) toward an output end (one end) in the signal line 1, a return current R1 flows toward the other end from the one end in a direction opposite to a flowing direction of the signal S. In the high-delay mode, since the first electronic switch 7a and the second electronic switch 7b are in the open state, the return current R1 mainly flows through the first outer line 3a and the second outer line 3b as shown in FIG. 3.

In the high-delay mode, since the return current R1 flows through the first outer line 3a and the second outer line 3b, an inductance value L is greater than that in the low-delay mode. In the high-delay mode, a larger delay amount can be obtained than that in the low-delay mode. In addition, in the high-delay mode, when the fourth electronic switch 7d is in the closed state, the other end of the signal line 1 and the second ground conductor 4b are electrically connected by the capacitor 5. Therefore, a capacitance value C of the digital phase shift circuit 10 in the high-delay mode is also greater than that in the low-delay mode. Therefore, in the high-delay mode, a larger delay amount can be obtained than that in the low-delay mode.

### Low-Delay Mode

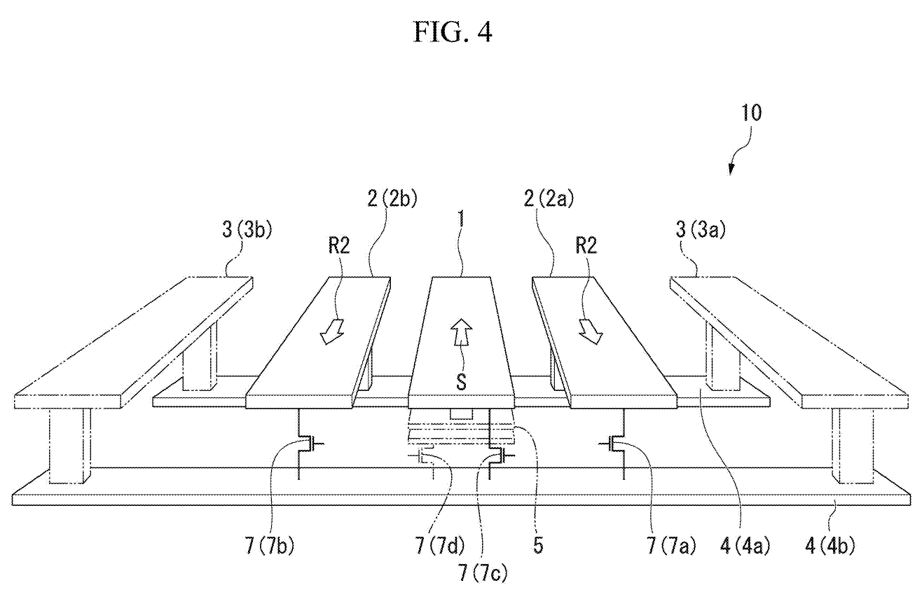

FIG. 4 is a diagram showing the low-delay mode of the digital phase shift circuit according to the first embodiment of the present invention. The low-delay mode is a mode in which a second passing phase smaller than the first passing phase is generated in the signal S. In the low-delay mode, as shown in FIG. 4, the first electronic switch 7a and the second electronic switch 7b are controlled to be in the closed state, and the fourth electronic switch 7d is controlled to be in the open state.

The first electronic switch 7a is controlled to be in the closed state, thereby causing a state where the other end of the first inner line 2a and the second ground conductor 4b are electrically connected. The second electronic switch 7b is controlled to be in the closed state, thereby causing a state where the other end of the second inner line 2b and the second ground conductor 4b are electrically connected.

When the signal S propagates from the input end (the other end) toward the output end (one end) in the signal line 1, a return current R2 flows toward the other end from the one end in a direction opposite to the flowing direction of the signal S. In the low-delay mode, since the first electronic switch 7a and the second electronic switch 7b are in the closed state, the return current R2 mainly flows through the first inner line 2a and the second inner line 2b as shown in FIG. 4.

In the low-delay mode, since the return current R2 flows through the first inner line 2a and the second inner line 2b, the inductance value L is smaller than that in the high-delay mode. The delay amount in the low-delay mode is smaller than the delay amount in the high-delay mode. In addition, although the capacitor 5 is connected to the other end of the signal line 1, the fourth electronic switch 7d is in the open state. Therefore, the capacitance of the capacitor 5 does not function, and only a parasitic capacitance that is extremely smaller compared to the capacitance of the capacitor 5 is present. Therefore, in the low-delay mode, a smaller delay amount can be obtained, compared to that in the high-delay mode.

Here, in the low-delay mode, since the third electronic switch 7c is controlled to be in the closed state, a loss of the signal line 1 can be intentionally increased. Thus, the loss of a high-frequency signal in the low-delay mode can be set to be approximately the same as the loss of a high-frequency signal in the high-delay mode.

That is, in some cases, the loss of the high-frequency signal in the low-delay mode may be smaller than the loss of the high-frequency signal in the high-delay mode. This loss difference causes an amplitude difference of the high-frequency signal output from the digital phase shift circuit 10, when the operation mode is switched between the low-delay mode and the high-delay mode. In response to these circumstances, the digital phase shift circuit 10 may eliminate the amplitude difference by controlling the third electronic switch 7c to be in the closed state in the low-delay mode. Depending on the design, the loss of the high-frequency signal in the low-delay mode may be greater than the loss of the high-frequency signal in the high-delay mode.

### Bend-Type Phase Shift Circuit

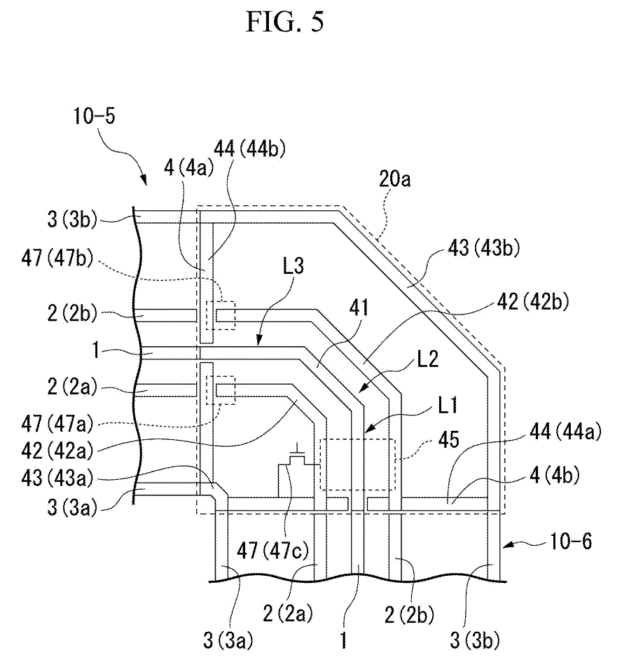

FIG. 5 is a plan view showing a configuration of the bend-type phase shift circuit according to the first embodiment of the present invention. The digital phase shifter 100 of the present embodiment includes the bend-type phase shift circuits 20a and 20b. However, since the bend-type phase shift circuits 20a and 20b have the same configuration, the bend-type phase shift circuit 20a is described here, and the bend-type phase shift circuit 20b is omitted in the description.

As shown in FIG. 5, the bend-type phase shift circuit 20a includes a signal line 41, a pair of inner lines 42 (first inner line 42a and second inner line 42b), a pair of outer lines 43 (first outer line 43a and second outer line 43b), a pair of ground conductors 44 (first ground conductor 44a and second ground conductor 44b), a capacitor 45, and three electronic switches 47 (first electronic switch 47a, second electronic switch 47b, and third electronic switch 47c).

The signal line 41 corresponds to the signal line 1 shown in FIG. 2, and the signal S flows through the signal line 41. The pair of inner lines 42 (first inner line 42a and second inner line 42b) correspond to the pair of inner lines 2 (first inner line 2a and second inner line 2b) shown in FIG. 2, and a current corresponding to the return current R2 shown in FIG. 4 flows through the pair of inner lines 42. The pair of outer lines 43 (first outer line 43a and second outer line 43b) correspond to the pair of outer lines 3 (first outer line 3a and second outer line 3b) shown in FIG. 2, and a current corresponding to the return current R1 shown in FIG. 3 flows through the pair of outer lines 43.

As shown in the drawing, the signal line 41, the pair of inner lines 42 (first inner line 42a and second inner line 42b), and the pair of outer lines 43 (first outer line 43a and second outer line 43b) are bent. Specifically, the first inner line 42a and the first outer line 43a are bent to be disposed on an inner bent side with respect to the signal line 41, and the second inner line 42b and the second outer line 43b are bent to be disposed on an outer bent side with respect to the signal line 41. The first outer line 43a is disposed on the inner bent side with respect to the first inner line 42a, and the second outer line 43b is disposed on the outer bent side with respect to the second inner line 42b. That is, in the present embodiment, the first outer line 43a is shorter than the second outer line 43b.

In an example shown in FIG. 5, each of the signal line 41, the pair of inner lines 42, and the pair of outer lines 43 is bent at two locations, and includes three straight portions. For example, the signal line 41 includes a first straight portion L1 extending in a direction (first direction) intersecting the first ground conductor 44a, a second straight portion L2 extending in an oblique direction with respect to the direction intersecting the first ground conductor 44a, and a third straight portion L3 extending in a direction (second direction) intersecting the second ground conductor 44b. Each of the pair of inner lines 42 also includes the first straight portion L1, the second straight portion L2, and the third straight portion L3.

One end of the signal line 41 is connected to the other end of the signal line 1 of the digital phase shift circuit 10-6, and the other end of the signal line 41 is connected to one end of the signal line 1 of the digital phase shift circuit 10-5. One end of each of the pair of inner lines 42 is disposed to face the other end of each of the pair of inner lines 2 of the digital phase shift circuit 10-6, and is electrically connected to the first ground conductor 44a. The other end of each of the pair of inner lines 42 is disposed to face one end of each of the pair of inner lines 2 of the digital phase shift circuit 10-5. One end of each of the pair of outer lines 43 is disposed to face the other end of each of the pair of outer lines 3 of the digital phase shift circuit 10-6, and is electrically connected to the first ground conductor 44a. The other end of each of the pair of outer lines 43 is disposed to face one end of each of the pair of outer lines 3 of the digital phase shift circuit 10-5, and is electrically connected to the second ground conductor 44b.

The pair of ground conductors 44 (first ground conductor 44a and second ground conductor 44b) correspond to the pair of ground conductors 4 (first ground conductor 4a and second ground conductor 4b) shown in FIG. 2. However, the first ground conductor 44a and the second ground conductor 44b are disposed such that extended lines therefrom intersect (for example, are orthogonal to) each other. The first ground conductor 44a and the second ground conductor 44b are not physically directly connected.

The first ground conductor 44a is set such that one end (left end in FIG. 5) thereof in the left-right direction on a paper surface is located at substantially the same position as the left side edge portion of the first outer line 3a of the digital phase shift circuit 10-6 in the left-right direction on the paper surface. In addition, the first ground conductor 44a is set such that the other end (right end in FIG. 5) thereof in the left-right direction on the paper surface is located at substantially the same position as the right side edge portion of the second outer line 3b of the digital phase shift circuit 10-6 in the left-right direction on the paper surface. In the example shown in FIG. 5, the left-right direction on the paper surface is a direction in which the first ground conductor 44a extends.

The second ground conductor 44b is set such that one end (lower end in FIG. 5) thereof in the up-down direction on the paper surface is located at substantially the same position as the lower side edge portion of the first outer line 3a of the digital phase shift circuit 10-5 in the up-down direction on the paper surface. In addition, the second ground conductor 44b is set such that the other end (upper end in FIG. 5) thereof in the up-down direction on the paper surface is located at substantially the same position as the upper side edge portion of the second outer line 3b of the digital phase shift circuit 10-5 in the up-down direction on the paper surface. In the example shown in FIG. 5, the up-down direction on the paper surface is a direction in which the second ground conductor 44b extends.

Therefore, it can be described that one end of the first outer line 43a is electrically connected to the first ground conductor 44a at a position of one end of the first ground conductor 44a, and the other end of the first outer line 43a is electrically connected to the second ground conductor 44b at a position of one end of the second ground conductor 44b. Similarly, it can be described that one end of the second outer line 43b is electrically connected to the first ground conductor 44a at a position of the other end of the first ground conductor 44a, and the other end of the second outer line 43b is electrically connected to the second ground conductor 44b at a position of the other end of the second ground conductor 44b.

As an example, FIG. 5 shows a configuration in which the second ground conductor 44b of the bend-type phase shift circuit 20a is shared with the first ground conductor 4a of the digital phase shift circuit 10-5, and the first ground conductor 44a of the bend-type phase shift circuit 20a is shared with the second ground conductor 4b of the digital phase shift circuit 10-6. However, the second ground conductor 44b of the bend-type phase shift circuit 20a and the first ground conductor 4a of the digital phase shift circuit 10-5 may not be shared with each other, and the first ground conductor 44a of the bend-type phase shift circuit 20a and the second ground conductor 4b of the digital phase shift circuit 10-6 may not be shared with each other.

The capacitor 45 corresponds to the capacitor 5 shown in FIG. 2, and is provided between one end of the signal line 41 and the first ground conductor 44a. For example, in the capacitor 45, the upper electrode thereof is electrically connected to the signal line 41, and the lower electrode thereof is electrically connected to the third electronic switch 47c.

The three electronic switches 47 (first electronic switch 47a, second electronic switch 47b, and third electronic switch 47c) correspond to the three electronic switches 7 (first electronic switch 7a, second electronic switch 7b, and fourth electronic switch 7d) shown in FIG. 2. As in the three electronic switches 7 shown in FIG. 2, the three electronic switches 47 are controlled by the switch control unit 8.

The first electronic switch 47a is located between the other end of the first inner line 42a and the second ground conductor 44b, and is electrically connected to the other end of the first inner line 42a and the second ground conductor 44b. Under the control of the switch control unit 8, the first electronic switch 47a is brought into a conductive state where the other end of the first inner line 42a and the second ground conductor 44b are electrically connected or into a cutoff state where the electrical connection therebetween is cut off.

The second electronic switch 47b is located between the other end of the second inner line 42b and the second ground conductor 44b, and is electrically connected to the other end of the second inner line 42b and the second ground conductor 44b. Under the control of the switch control unit 8, the second electronic switch 47b is brought into a conductive state where the other end of the second inner line 42b and the second ground conductor 44b are electrically connected or into a cutoff state where the electrical connection therebetween is cut off.

The third electronic switch 47c is connected in series to the capacitor 45 between one end of the signal line 41 and the first ground conductor 44a. Under the control of the switch control unit 8, the third electronic switch 47c is brought into a conductive state where the lower electrode of the capacitor 45 and the first ground conductor 44a are electrically connected or into a cutoff state where the electrical connection therebetween is cut off.

As an example, FIG. 5 shows a configuration in which the capacitor 45 and the third electronic switch 47c are provided on the digital phase shift circuit 10-6 side, and the capacitor 45 is electrically connected between one end of the signal line 41 and the first ground conductor 44a. However, a configuration may be adopted in which the capacitor 45 and the third electronic switch 47c are provided on the digital phase shift circuit 10-5 side, and the capacitor 45 is electrically connected between the other end of the signal line 41 and the second ground conductor 44b.

As in the digital phase shift circuit 10 shown in FIG. 2, operation modes of the bend-type phase shift circuit 20a formed in this way includes the high-delay mode and the low-delay mode, and the bend-type phase shift circuit 20a is operated in the high-delay mode or in the low-delay mode. That is, the bend-type phase shift circuit 20a is operated in the high-delay mode when the first electronic switch 47a and the second electronic switch 47b shown in FIG. 5 are controlled to be in the open state and the third electronic switch 47c is controlled to be in the closed state. In addition, the bend-type phase shift circuit 20a is operated in the low-delay mode when the first electronic switch 47a and the second electronic switch 47b shown in FIG. 5 are controlled to be in the closed state and the third electronic switch 47c is controlled to be in the open state.

Here, the second outer line 43b of the bend-type phase shift circuit 20a is longer than the outer line 3 of the digital phase shift circuit 10 shown in FIG. 2, and an inductive component of the second outer line 43b is larger than an inductive component of the outer line 3 of the digital phase shift circuit 10 shown in FIG. 2. Accordingly, it is considered that the amount of phase shift of the bend-type phase shift circuit 20a is larger than the amount of phase shift of the digital phase shift circuit 10 shown in FIG. 2. However, since the first outer line 43a of the bend-type phase shift circuit 20a is shorter than the second outer line 43b and the outer line 3 of the digital phase shift circuit 10 shown in FIG. 2, the inductive component of the first outer line 43a is smaller than the inductive component of the second outer line 43b and the inductive component of the outer line 3 of the digital phase shift circuit 10 shown in FIG. 2. Therefore, in the bend-type phase shift circuit 20a, an effect of the inductive component of the second outer line 43b is canceled by the first outer line 43a, and the amount of phase shift of the bend-type phase shift circuit 20a can be maintained to be small (for example, to be approximately the same amount of phase shift of the digital phase shift circuit 10 shown in FIG. 2).

The digital phase shift circuits 10-5 and 10-6 electrically connected by the bend-type phase shift circuit 20a are in a separated state. For example, in a proximity portion C1 shown in FIG. 1, the digital phase shift circuits 10-5 and 10-6 are in the separated state such that the first ground conductor 4a of the digital phase shift circuit 10-5 (which is shared with the second ground conductor 44b in FIG. 5) and the second ground conductor 4b of the digital phase shift circuit 10-6 (which is shared with the first ground conductor 44a in FIG. 5) do not come into contact with each other. This is because if the first ground conductor 4a of the digital phase shift circuit 10-5 and the second ground conductor 4b of the digital phase shift circuit 10-6 are in contact with each other, the return current takes a shortcut in the bend-type phase shift circuit 20a, and affects a phase shift operation of the bend-type phase shift circuit 20a.

Similarly, the digital phase shift circuits 10-6 and 10-7 electrically connected by the bend-type phase shift circuit 20b are also in the separated state. For example, in a proximity portion C2 shown in FIG. 1, the digital phase shift circuits 10-6 and 10-7 are in the separated state such that the first ground conductor 4a of the digital phase shift circuit 10-6 and the second ground conductor 4b of the digital phase shift circuit 10-7 do not come into contact with each other. This is because if the first ground conductor 4a of the digital phase shift circuit 10-6 and the second ground conductor 4b of the digital phase shift circuit 10-7 are in contact with each other, the return current takes a shortcut in the bend-type phase shift circuit 20b, and affects a phase shift operation of the bend-type phase shift circuit 20b.

In the present embodiment, so to speak, the bend-type phase shift circuits 20a and 20b correspond to circuits in which the digital phase shift circuit 10 shown in FIG. 2 is bent by 90°. Therefore, without significantly increasing the mounting area, a function of bending the path of the signal S by 90° and a function as a phase shifter can be realized.

### Operation of Digital Phase Shifter

The digital phase shifter 100 can realize various types of delays (amount of phase shift) by setting the operation modes of the digital phase shift circuits 10 and the bend-type phase shift circuits 20a and 20b which form the digital phase shifter 100 to the high-delay mode or the low-delay mode. For example, the operation of the digital phase shifter 100 includes two operations described below.

### · First Operation

The first operation is an operation in which all of the digital phase shift circuits 10 and the bend-type phase shift circuits 20a and 20b are sequentially switched to the low-delay mode from a state where all of the digital phase shift circuits 10 and the bend-type phase shift circuits 20a and 20b are in the high-delay mode, in a connection order of the digital phase shift circuits 10 and the bend-type phase shift circuits 20a and 20b from the digital phase shift circuit 10-1 to the digital phase shift circuit 10-11. That is, in the first operation, the digital phase shift circuits 10-1 to 10-5, the bend-type phase shift circuit 20a, the digital phase shift circuit 10-6, the bend-type phase shift circuit 20b, and the digital phase shift circuits 10-7 to 10-11 are sequentially switched to the low-delay mode from the high-delay mode in this order.

### · Second Operation

The second operation is an operation in which all of the digital phase shift circuits 10 and the bend-type phase shift circuits 20a and 20b are sequentially switched to the high-delay mode from a state where all of the digital phase shift circuits 10 and the bend-type phase shift circuits 20a and 20b are in the low-delay mode, in a connection order of the digital phase shift circuits 10 and the bend-type phase shift circuits 20a and 20b from the digital phase shift circuit 10-1 to the digital phase shift circuit 10-11. That is, in the second operation, the digital phase shift circuits 10-1 to 10-5, the bend-type phase shift circuit 20a, the digital phase shift circuit 10-6, the bend-type phase shift circuit 20b, and the digital phase shift circuits 10-7 to 10-11 are sequentially switched to the high-delay mode from the low-delay mode in this order.

As described above, the bend-type phase shift circuits 20a and 20b of the present embodiment include the signal line 41, the pair of inner lines 42 provided on both sides of the signal line 41, the pair of outer lines 43 provided on outer sides of the pair of inner lines 42, the first ground conductor 44a electrically connected to one end of each of the pair of inner lines 42 and the pair of outer lines 43, the second ground conductor 44b electrically connected to the other end of each of the pair of outer lines 43 and not physically directly connected to the first ground conductor 44a, and the pair of electronic switches 47a and 47b respectively provided between the other ends of the pair of inner lines 42 and the second ground conductor 44b. The signal line 41, the pair of inner lines 42, and the pair of outer lines 43 are bent, and bend-type phase shift circuits 20a and 20b are set to the low-delay mode in which the pair of electronic switches 47a and 47b are in the closed state or to the high-delay mode in which the pair of electronic switches 47a and 47b are in the open state. In this manner, the bend-type phase shift circuits 20a and 20b in which a function as the phase shift circuit is added to a function of bending the path of the signal S by 90° which is a function of the connection portion in the related art can be realized.

Since the bend-type phase shift circuits 20a and 20b have the function of bending the path of the signal S by 90° and the function as the phase shift circuit, even when the number of bending times of the digital phase shifter 100 increases, an occupied area of a portion that does not function as the phase shifter does not increase. As a result, the mounting area of the digital phase shifter can be decreased, compared to that in the related art.

### Modification Example

Hereinafter, modification examples of the bend-type phase shift circuit according to the first embodiment of the present invention are described. In the drawings used in the following description, the same reference numerals are assigned to the configurations corresponding to the configurations shown in FIG. 5. In addition, in the following description as well, the bend-type phase shift circuit 20a is described, and the bend-type phase shift circuit 20b is omitted in the description.

### First Modification Example

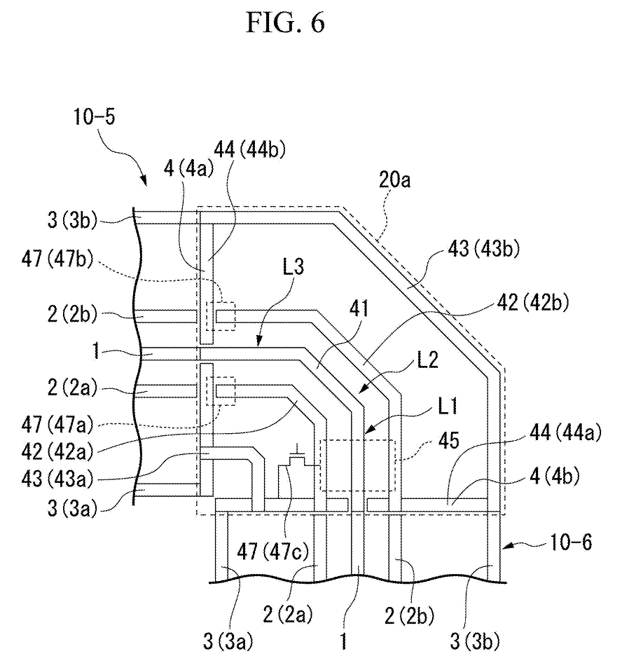

FIG. 6 is a plan view showing the configuration of a bend-type phase shift circuit according to a first modification example in the first embodiment of the present invention. As shown in FIG. 6, a bend-type phase shift circuit 20a of the present modification example is obtained by changing a connection position and the length of the first outer line 43a thereof as compared to the bend-type phase shift circuit 20a shown in FIG. 5.

In the bend-type phase shift circuit 20a shown in FIG. 5, one end of the first outer line 43a is electrically connected to the first ground conductor 44a at a position of one end of the first ground conductor 44a, and the other end of the first outer line 43a is electrically connected to the second ground conductor 44b at a position of one end of the second ground conductor 44b. In contrast, in the bend-type phase shift circuit 20a of the present modification example, one end of the first outer line 43a is electrically connected to the first ground conductor 44a at a position separated from one end of the first ground conductor 44a, and the other end of the first outer line 43a is electrically connected to the second ground conductor 44b at a position separated from one end of the second ground conductor 44b.

The length of the first outer line 43a can be adjusted by changing the connection position of the first outer line 43a with respect to the first ground conductor 44a and the second ground conductor 44b. In this manner, a degree to which the effect of the inductive component of the second outer line 43b is canceled by the first outer line 43a can be adjusted. Therefore, the amount of phase shift of the bend-type phase shift circuit 20a can be adjusted. When the length of the first outer line 43a is increased, the amount of phase shift of the bend-type phase shift circuit 20a can be increased. On the contrary, when the length of the first outer line 43a is decreased, the amount of phase shift of the bend-type phase shift circuit 20a can be decreased.

### Second Modification Example

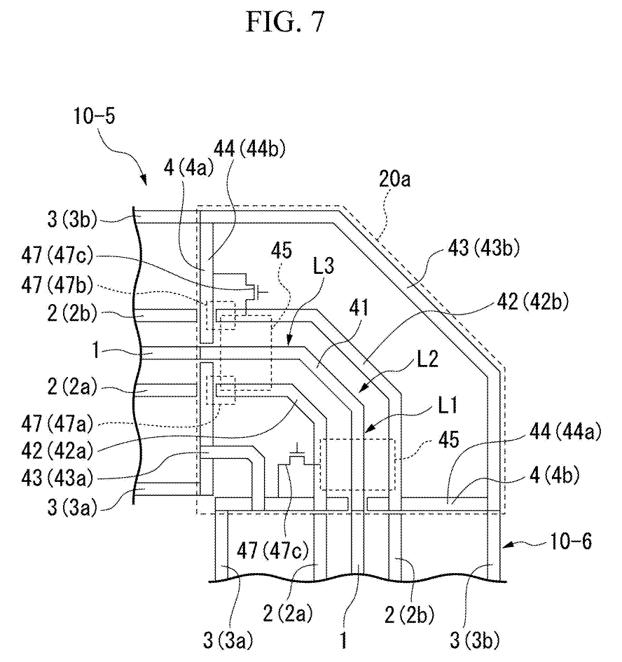

FIG. 7 is a plan view showing the configuration of a bend-type phase shift circuit according to a second modification example in the first embodiment of the present invention. As shown in FIG. 7, in the bend-type phase shift circuit 20a of the present modification example, the capacitor 45 and the third electronic switch 47c are also provided on the digital phase shift circuit 10-5 side as compared to the bend-type phase shift circuit 20a shown in FIG. 6.

The capacitor 45 provided on the digital phase shift circuit 10-5 side is provided between the other end of the signal line 41 and the second ground conductor 44b. For example, in the capacitor 45 provided on the digital phase shift circuit 10-5 side, the upper electrode thereof is electrically connected to the signal line 41, and the lower electrode thereof is electrically connected to the third electronic switch 47c provided on the digital phase shift circuit 10-5 side.

The third electronic switch 47c provided on the digital phase shift circuit 10-5 side is connected in series to the capacitor 45 provided on the digital phase shift circuit 10-5 side between the other end of the signal line 41 and the second ground conductor 44b. Under the control of the switch control unit 8, the third electronic switch 47c provided on the digital phase shift circuit 10-5 side is brought into a conductive state where the lower electrode of the capacitor 45 provided on the digital phase shift circuit 10-5 side and the second ground conductor 44b are electrically connected or into a cutoff state where the electrical connection therebetween is cut off.

Since the capacitor 45 and the third electronic switch 47c are provided on the digital phase shift circuit 10-5 side and the digital phase shift circuit 10-6 side, the bend-type phase shift circuit 20a can be symmetrical. In this manner, characteristics of the bend-type phase shift circuit 20a when viewed from the digital phase shift circuit 10-5 side and characteristics of the bend-type phase shift circuit 20a when viewed from the digital phase shift circuit 10-6 side can coincide with each other (or can have the same characteristics).

### Third Modification Example

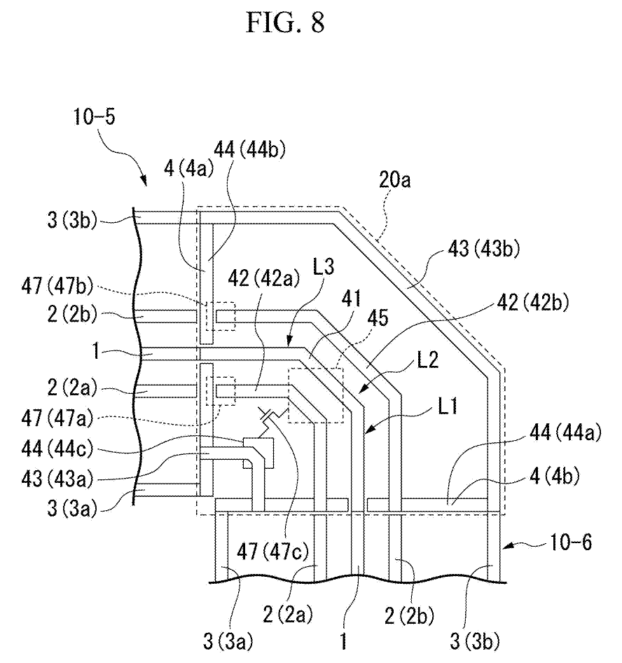

FIG. 8 is a plan view showing the configuration of a bend-type phase shift circuit according to a third modification example in the first embodiment of the present invention. As shown in FIG. 8, in the bend-type phase shift circuit 20a of the present modification example, the third ground conductor 44c is added, the capacitor 45 is moved to a center portion of the signal line 41 in a plan view, and the third electronic switch 47c is provided between the capacitor 45 and the third ground conductor 44c, as compared to the bend-type phase shift circuit 20a shown in FIG. 6.

For example, the third ground conductor 44c is a rectangular conductor formed in the same layer as the first ground conductor 44a and the second ground conductor 44b. The third ground conductor 44c is located to overlap the center portion of the first outer line 43a in a plan view. For example, the third ground conductor 44c is electrically connected to the center portion of the first outer line 43a by the same connection conductor as the connection conductor 6 shown in FIG. 2. The shape (shape in a plan view) of the third ground conductor 44c is not limited to the rectangular shape, and any shape may be adopted.

In the capacitor 45, the upper electrode thereof is electrically connected to the center portion of the signal line 41, and the lower electrode thereof is electrically connected to the third electronic switch 47c. The third electronic switch 47c is connected in series to the capacitor 45 between the center portion of the signal line 41 and the third ground conductor 44c in a plan view. Under the control of the switch control unit 8, the third electronic switch 47c is brought into a conductive state where the lower electrode of the capacitor 45 and the third ground conductor 44c are electrically connected or into a cutoff state where the electrical connection therebetween is cut off.

Since a configuration is adopted in which the third ground conductor 44c is located to overlap the center portion of the first outer line 43a in a plan view and the capacitor 45 is located at the center portion of the signal line 41 in a plan view, the bend-type phase shift circuit 20a can be symmetrical. In this manner, characteristics of the bend-type phase shift circuit 20a when viewed from the digital phase shift circuit 10-5 side and characteristics of the bend-type phase shift circuit 20a when viewed from the digital phase shift circuit 10-6 side can coincide with each other (or can have the same characteristics).

### Fourth Modification Example

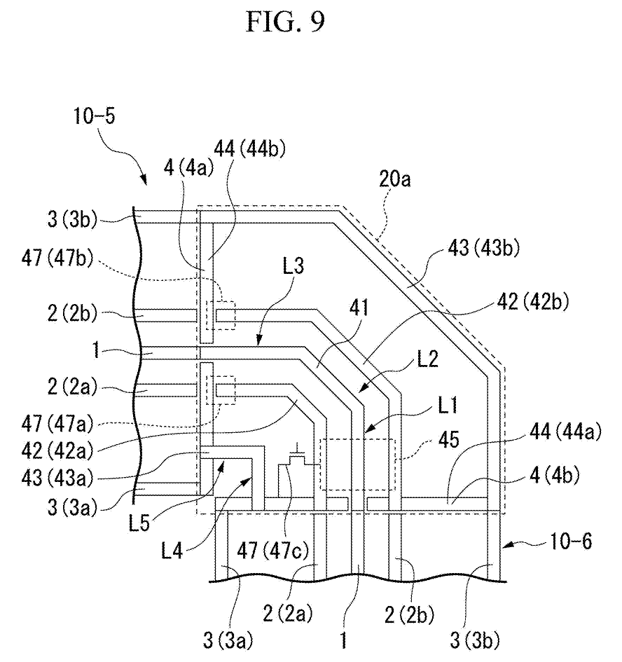

FIG. 9 is a plan view showing the configuration of a bend-type phase shift circuit according to a fourth modification example in the first embodiment of the present invention. As shown in FIG. 9, the bend-type phase shift circuit 20a of the present modification example has a shape obtained by bending the first outer line 43a at a right angle as compared to the bend-type phase shift circuit 20a shown in FIG. 6. That is, the first outer line 43a includes a fourth straight portion L4 extending in a direction (first direction) intersecting the first ground conductor 44a, and a fifth straight portion L5 extending in a direction (second direction) intersecting the second ground conductor 44b.

The first outer line 43a has a shape that is bent at a right angle. Therefore, in the first outer line 43a, a portion parallel to the second straight portion L2 of the signal line 41 can be removed. In this manner, a mutual inductance between the first outer line 43a and the second straight portion L2 of the signal line 41 can be reduced.

### Fifth Modification Example

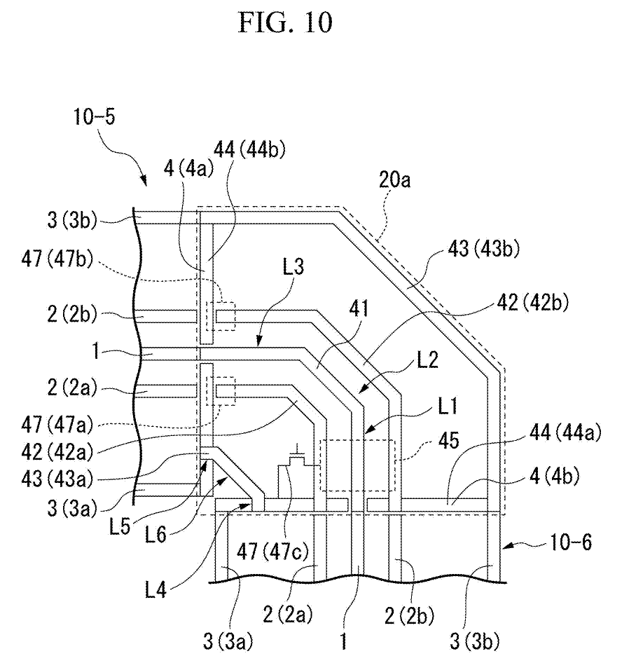

FIG. 10 is a plan view showing the configuration of a bend-type phase shift circuit according to a fifth modification example in the first embodiment of the present invention. As shown in FIG. 10, the bend-type phase shift circuit 20a of the present modification example has a shape in which in addition to the fourth straight portion L4 and the fifth straight portion L5, the first outer line 43a further includes a first oblique straight portion L6 extending in an oblique direction with respect to a direction intersecting the first ground conductor 44a, as compared to the bend-type phase shift circuit 20a shown in FIG. 9. The first outer line 43a is designed such that a proportion of the first oblique straight portion L6 increases. That is, in the first outer line 43a, the length of the first oblique straight portion L6 is longer than the lengths of the fourth straight portion L4 and the fifth straight portion L5, and the fourth straight portion L4 and the fifth straight portion L5 are as short as possible.

The first outer line 43a is designed such that a proportion of the first oblique straight portion L6 therein increases. Therefore, in the first outer line 43a, almost all of portions parallel to the first straight portion L1 and the third straight portion L3 of the signal line 41 can be removed. In this manner, the mutual inductance between the first oblique straight portion L6 of the first outer line 43a and the first straight portion L1 and the third straight portion L3 of the signal line 41 can be reduced.

### Sixth Modification Example

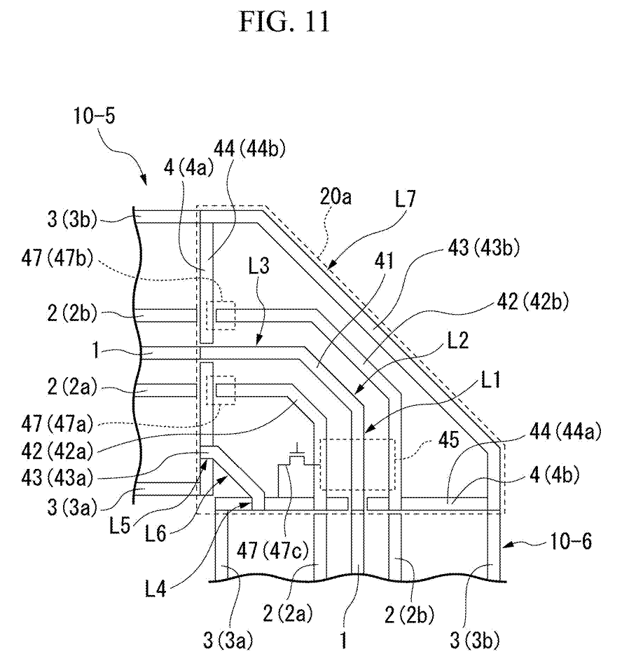

FIG. 11 is a plan view showing the configuration of a bend-type phase shift circuit according to a sixth modification example in the first embodiment of the present invention. As shown in FIG. 11, in the bend-type phase shift circuit 20a of the present modification example, a proportion of a second oblique straight portion L7 of the second outer line 43b is increased as compared to the bend-type phase shift circuit 20a shown in FIG. 10. The second oblique straight portion L7 of the second outer line 43b extends in an oblique direction with respect to the direction intersecting the first ground conductor 44a, and is a portion parallel to the second straight portions L2 of the signal line 41 and the pair of inner lines 42.

The first outer line 43a may include only the first oblique straight portion L6 by omitting the fourth straight portion L4 and the fifth straight portion L5.

The first outer line 43a is designed such that the proportion of the first oblique straight portion L6 therein increases, and the second outer line 43b is designed such that the proportion of the second oblique straight portion L7 therein increases. Therefore, in the first outer line 43a, almost all of portions parallel to the first straight portion L1 and the third straight portion L3 of the signal line 41 can be removed. In addition, in the second outer line 43b, the portion parallel to the first straight portion L1 and the third straight portion L3 of the signal line 41 can be reduced. In this manner, the mutual inductance between the first oblique straight portion L6 of the first outer line 43a and the first straight portion L1 and the third straight portion L3 of the signal line 41 and the mutual inductance between the second oblique straight portion L7 of the second outer line 43b and the first straight portion L1 and the third straight portion L3 of the signal line 41 can be reduced.

### Seventh Modification Example

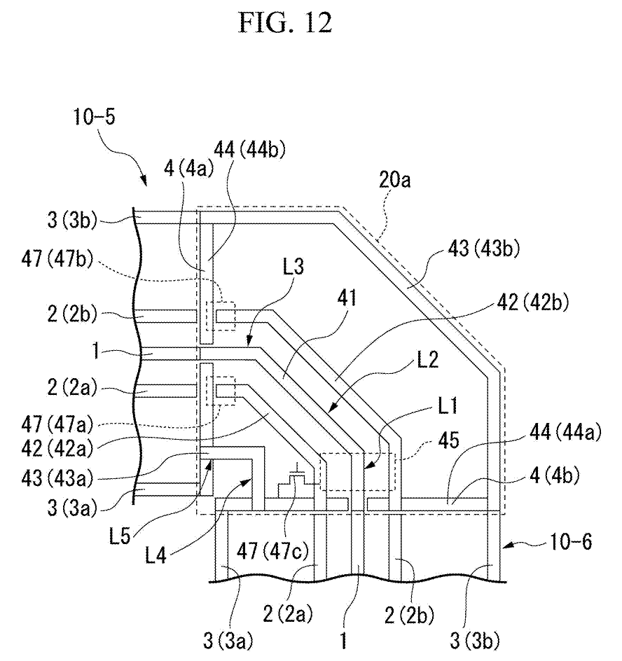

FIG. 12 is a plan view showing the configuration of a bend-type phase shift circuit according to a seventh modification example in the first embodiment of the present invention. As shown in FIG. 12, in the bend-type phase shift circuit 20a of the present modification example, the proportion of the second straight portion L2 of each of the signal line 41 and the pair of inner lines 42 is increased as compared to the bend-type phase shift circuit 20a shown in FIG. 9.

The length of the second straight portion L2 of the signal line 41 is longer than the lengths of the first straight portion L1 and the third straight portion L3 of the signal line 41. Similarly, the length of the second straight portion L2 of the pair of inner lines 42 is longer than the lengths of the first straight portion L1 and the third straight portion L3 of the pair of inner lines 42. That is, the length of the second straight portion L2 of the first inner line 42a is longer than the lengths of the first straight portion L1 and the third straight portion L3 of the first inner line 42a, and the length of the second straight portion L2 of the second inner line 42b is longer than the lengths of the first straight portion L1 and the third straight portion L3 of the second inner line 42b.

The signal line 41 and the pair of inner lines 42 are designed such that the proportion of the second straight portion L2 therein increases. Therefore, in the signal line 41 and the pair of inner lines 42, the portions parallel to the first outer line 43a can be reduced. In this manner, a mutual inductance between the first outer line 43a and the second straight portion L2 of the signal line 41 can be reduced.

### Eighth Modification Example

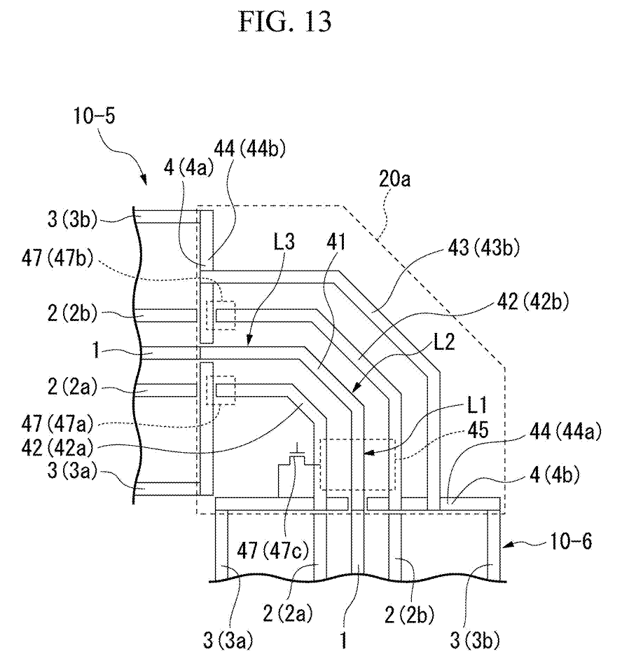

FIG. 13 is a plan view showing the configuration of a bend-type phase shift circuit according to an eighth modification example in the first embodiment of the present invention. As shown in FIG. 13, in the bend-type phase shift circuit 20a of the present modification example, the first outer line 43a is omitted, and the connection position and the length of the second outer line 43b are changed as compared to the bend-type phase shift circuit 20a shown in FIG. 5.

In the bend-type phase shift circuit 20a shown in FIG. 5, one end of the second outer line 43b is electrically connected to the first ground conductor 44a at a position of the other end of the first ground conductor 44a, and the other end of the second outer line 43b is electrically connected to the second ground conductor 44b at a position of the other end of the second ground conductor 44b. In contrast, in the bend-type phase shift circuit 20a of the present modification example, one end of the second outer line 43b is electrically connected to the first ground conductor 44a at a position separated from the other end of the first ground conductor 44a, and the other end of the second outer line 43b is electrically connected to the second ground conductor 44b at a position separated from the other end of the second ground conductor 44b.

Since the first outer line 43a is omitted, the amount of phase shift of the bend-type phase shift circuit 20a can be increased. In addition, the length of the second outer line 43b can be adjusted by changing the connection position of the second outer line 43b with respect to the first ground conductor 44a and the second ground conductor 44b. In this manner, since a magnitude of the inductive component of the second outer line 43b can be adjusted, the amount of phase shift of the bend-type phase shift circuit 20a can be adjusted. When the length of the second outer line 43b is increased, the amount of phase shift of the bend-type phase shift circuit 20a can be increased. On the contrary, when the length of the second outer line 43b is decreased, the amount of phase shift of the bend-type phase shift circuit 20a can be decreased.

### Ninth Modification Example

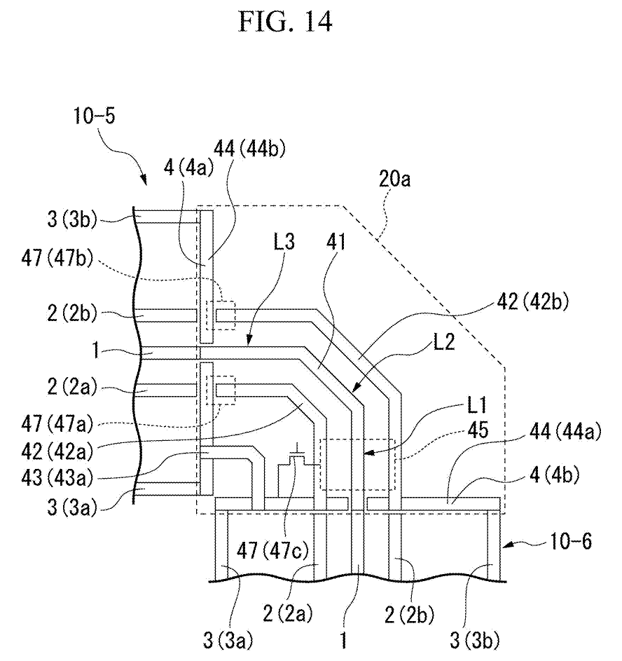

FIG. 14 is a plan view showing the configuration of a bend-type phase shift circuit according to a ninth modification example in the first embodiment of the present invention. As shown in FIG. 14, in the bend-type phase shift circuit 20a of the present modification example, the second outer line 43b is omitted as compared to the bend-type phase shift circuit 20a shown in FIG. 6.

Since the second outer line 43b is omitted, the amount of phase shift of the bend-type phase shift circuit 20a can be changed. For example, the amount of phase shift of the bend-type phase shift circuit 20a of the present modification example can be set to the amount of phase shift between the amount of phase shift of the bend-type phase shift circuit 20a shown in FIG. 5 and the amount of phase shift of the bend-type phase shift circuit 20a shown in FIG. 13.

### Tenth Modification Example

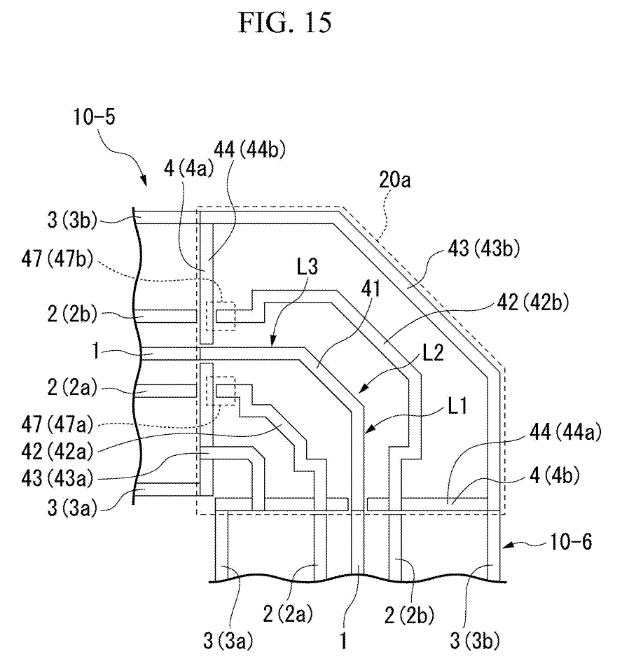

FIG. 15 is a plan view showing the configuration of a bend-type phase shift circuit according to a tenth modification example in the first embodiment of the present invention. As shown in FIG. 15, in the bend-type phase shift circuit 20a of the present modification example, the pair of inner lines 42 are located away from the signal line 41 as compared to the bend-type phase shift circuit 20a shown in FIG. 6. However, both ends of the pair of inner lines 42 respectively need to face the pair of inner lines 2 of the digital phase shift circuits 10-6 and 10-5. Therefore, both ends of the pair of inner lines 42 of the present modification example are disposed at the same positions as those in the above-described embodiment and modification examples.

The first inner line 42a includes a first protruding portion extending from one end portion thereof toward the first outer line 43a in a direction along the first ground conductor 44a, and a second protruding portion extending from the other end portion thereof toward the first outer line 43a in a direction along the second ground conductor 44b. The first protruding portion is located in an intermediate portion of the first straight portion L1 of the first inner line 42a. That is, in the first straight portion L1 of the first inner line 42a, two portions are separated with the first protruding portion therebetween and connected by the first protruding portion. The second protruding portion is located in an intermediate portion of the third straight portion L3 of the first inner line 42a. That is, in the third straight portion L3 of the first inner line 42a, two portions are separated with the second protruding portion therebetween and connected by the second protruding portion.

The second inner line 42b includes a third protruding portion extending from one end portion thereof toward the second outer line 43b in a direction along the first ground conductor 44a, and a fourth protruding portion extending from the other end portion thereof toward the second outer line 43b in a direction along the second ground conductor 44b. The third protruding portion is located in an intermediate portion of the first straight portion L1 of the second inner line 42b. That is, in the first straight portion L1 of the second inner line 42b, two portions are separated with the third protruding portion therebetween and connected by the third protruding portion. The fourth protruding portion is located in an intermediate portion of the third straight portion L3 of the second inner line 42b. That is, in the third straight portion L3 of the second inner line 42b, two portions are separated with the fourth protruding portion therebetween and connected by the fourth protruding portion.

Since a part of the pair of inner lines 42 is located away from the signal line 41, the amount of phase shift of the bend-type phase shift circuit 20a can be reduced. How far the pair of inner lines 42 is located away from the signal line 41 is set in view of the amount of phase shift of the bend-type phase shift circuit 20a.

### Second Embodiment

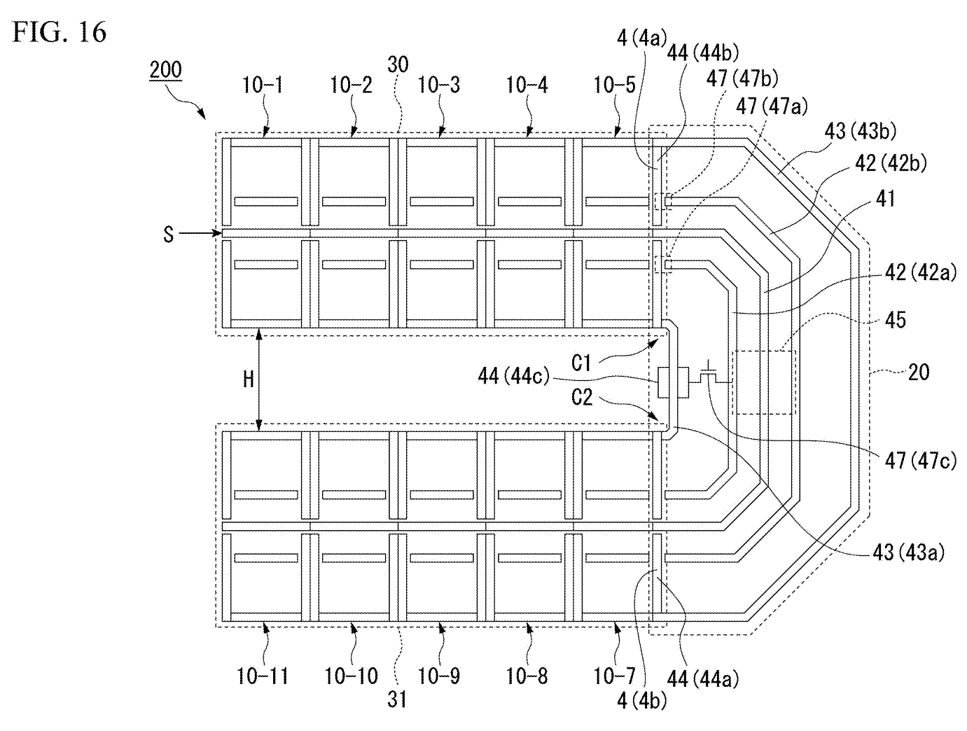

FIG. 16 is a plan view showing the schematic configuration of a digital phase shifter according to a second embodiment of the present invention. In FIG. 16, the same reference numerals are assigned to the configuration corresponding to the configurations shown in FIGS. 1 to 15. As shown in FIG. 16, a digital phase shifter 200 of the present embodiment has a configuration in which the bend-type phase shift circuit 20 is provided instead of the bend-type phase shift circuits 20a and 20b and the digital phase shift circuit 10-6 of the digital phase shifter 100 of the first embodiment.

Each of the bend-type phase shift circuits 20a and 20b of the digital phase shifter 100 of the first embodiment shown in FIG. 1 is a 90° bend-type phase shift circuit that realizes a function of bending the path of the signal S by 90° and a function as the phase shift circuit. In contrast, the bend-type phase shift circuit 20 of the digital phase shifter 200 of the present embodiment is a 180° bend-type phase shift circuit that realizes a function of bending the path of the signal Sby 180° and a function as the phase shift circuit. The bend-type phase shift circuit 20 connects the digital phase shift circuit 10-5 (first digital phase shift circuit) located at one end portion of the first digital phase shift circuit group 30 and the digital phase shift circuit 10-7 (second digital phase shift circuit) located at one end portion of the second digital phase shift circuit group 31.

As in the bend-type phase shift circuit 20a shown in FIG. 8, the bend-type phase shift circuit 20 includes the signal line 41, the pair of inner lines 42 (first inner line 42a and second inner line 42b), the pair of outer lines 43 (first outer line 43a and second outer line 43b), the pair of ground conductors 44 (first ground conductor 44a and second ground conductor 44b), the third ground conductor 44c, the capacitor 45, and the three electronic switches 47 (first electronic switch 47a, second electronic switch 47b, and third electronic switch 47c).

Since the bend-type phase shift circuit 20a shown in FIG. 8 is the 90° bend-type phase shift circuit, the signal line 41, the pair of inner lines 42, and the pair of outer lines 43 thereof are bent in a substantially L-shape. In contrast, since the bend-type phase shift circuit 20 of the present embodiment is the 180° bend-type phase shift circuit, the signal line 41, the pair of inner lines 42, and the pair of outer lines 43 thereof are bent in a substantially U-shape.

In addition, since the bend-type phase shift circuit 20a shown in FIG. 8 is the 90° bend-type phase shift circuit, the first ground conductor 44a and the second ground conductor 44b thereof are disposed such that extended lines therefrom are orthogonal to each other. In contrast, since the bend-type phase shift circuit 20 of the present embodiment is the 180° bend-type phase shift circuit, the first ground conductor 44a and the second ground conductor 44b are disposed on a straight line. The first ground conductor 44a and the second ground conductor 44b may be disposed such that the extended lines therefrom are parallel to each other. Also, in the present embodiment, the first ground conductor 44a and the second ground conductor 44b are not physically directly connected.

The third ground conductor 44c is located to overlap the center portion of the first outer line 43a in a plan view. For example, the third ground conductor 44c is electrically connected to the center portion of the first outer line 43a by the same connection conductor as the connection conductor 6 shown in FIG. 2. In the capacitor 45, the upper electrode thereof is electrically connected to the center portion of the signal line 41, and the lower electrode thereof is electrically connected to the third electronic switch 47c. The third electronic switch 47c is connected in series to the capacitor 45 between the center portion of the signal line 41 and the third ground conductor 44c.

As in the bend-type phase shift circuits 20a and 20b of the first embodiment, the bend-type phase shift circuit 20 of the present embodiment includes the signal line 41, the pair of inner lines 42 provided on both sides of the signal line 41, the pair of outer lines 43 provided on the outer sides of the pair of inner lines 42, the first ground conductor 44a electrically connected to one end of each of the pair of inner lines 42 and the pair of outer lines 43, the second ground conductor 44b electrically connected to the other ends of the pair of outer lines 43 and not physically directly connected to the first ground conductor 44a, and the pair of electronic switches 47a and 47b respectively provided between the other ends of the pair of inner lines 42 and the second ground conductor 44b. The signal line 41, the pair of inner lines 42, and the pair of outer lines 43 are bent, and the operation mode of the bend-type phase shift circuit 20 is set to the low-delay mode in which the pair of electronic switches 47a and 47b are in the closed state or set to the high-delay mode in which the pair of electronic switches 47a and 47b are in the open state. In this manner, the bend-type phase shift circuit 20 in which the function as the phase shift circuit is added to the function of bending the path of the signal S by 180° which is the function of the connection portion in the related art can be realized.

Since the bend-type phase shift circuit 20 has the function of bending the path of the signal S by 180° and the function as the phase shift circuit, even when the number of bending times of the digital phase shifter 200 increases, an occupied area of the portion that does not function as the phase shift circuit does not increase. As a result, the mounting area of the digital phase shifter can be decreased, compared to that in the related art.

In addition, as in the bend-type phase shift circuit 20a shown in FIG. 8, the bend-type phase shift circuit 20 of the present embodiment has a configuration in which the third ground conductor 44c is located to overlap the center portion of the first outer line 43a in a plan view and the capacitor 45 is located at the center portion of the signal line 41 in a plan view, and has a symmetrical configuration. In this manner, characteristics of the bend-type phase shift circuit 20 when viewed from the digital phase shift circuit 10-5 side and characteristics of the bend-type phase shift circuit 20 when viewed from the digital phase shift circuit 10-7 side can coincide with each other (or can have the same characteristics).

Also, a part of the configurations of the first, second, and fourth to tenth modification examples of the first embodiment shown in FIGS. 6, 7 and 9 -15 can also be applied to the bend-type phase shift circuit 20 of the present embodiment. For example, a part of the configuration of the first modification example of the first embodiment shown in FIG. 6 may be applied to the bend-type phase shift circuit 20 of the present embodiment to adopt a configuration in which one end of the first outer line 43a is electrically connected to the first ground conductor 44a at a position separated from one end of the first ground conductor 44a, and the other end of the first outer line 43a is electrically connected to the second ground conductor 44b at a position separated from one end of the second ground conductor 44b. In addition, a part of the configuration of the eighth modification example of the first embodiment shown in FIG. 13 may be applied to the bend-type phase shift circuit 20 of the present embodiment to adopt a configuration in which one end of the second outer line 43b is electrically connected to the first ground conductor 44a at a position separated from the other end of the first ground conductor 44a, and the other end of the second outer line 43b is electrically connected to the second ground conductor 44b at a position separated from the other end of the second ground conductor 44b.

In addition, a part of the configuration of the second modification example of the first embodiment shown in FIG. 7 may be applied to the bend-type phase shift circuit 20 of the present embodiment to adopt a configuration in which the capacitor 45 and the third electronic switch 47c are provided on each of the digital phase shift circuit 10-5 side and the digital phase shift circuit 10-7 side. Alternatively, a part of the configuration of the eighth modification example of the first embodiment shown in FIG. 13 may be applied to the bend-type phase shift circuit 20 of the present embodiment to adopt a configuration in which the first outer line 43a is omitted, or a part of the configuration of the ninth modification example of the first embodiment shown in FIG. 14 may be applied to the bend-type phase shift circuit 20 of the present embodiment to adopt a configuration in which the second outer line 43b is omitted.

Although the embodiments of the present invention are described above, the above-described embodiments are only examples of the present invention and the present invention is not limited to the above-described embodiments, so additions, omissions, substitutions, and other modifications can be made within the scope of the present invention. Accordingly, the invention is not to be considered as being limited by the foregoing description and is only limited by the scope of the appended claims.

For example, the bend-type phase shift circuits 20a and 20b according to the first embodiment described above have a shape of the 90° bend, and the bend-type phase shift circuit 20 according to the second embodiment described above has a shape of the 180° bend. However, the bend-type phase shift circuit may have a shape other than the shape of the 90° bend and the shape of the 180° bend (for example, a shape of the 45° bend). When the bend-type phase shift circuit has the shape other than the shape of the 90° bend and the shape of the 180° bend, the first ground conductor 44a and the second ground conductor 44b are disposed such that the extended lines therefrom intersect each other.

In addition, the bend-type phase shift circuits 20a and 20b according to the first embodiment described above and the bend-type phase shift circuit 20 according to the second embodiment described above include the pair of inner lines 42 (first inner line 42a and second inner line 42b) provided on both sides of the signal line 41. However, the inner line 42 may be provided on only one side of the signal line 41. That is, a configuration in which only the first inner line 42a is provided may be adopted, or a configuration in which only the second inner line 42b is provided may be adopted.

In addition, the digital phase shifters 100 and 200 according to the first and second embodiments described above have the U-shape in a plan view. However, the digital phase shifter may have a shape other than the U-shape in a plan view (for example, a spiral shape or a meandering shape). The digital phase shifter having this shape is realized by connecting the plurality of digital phase shift circuit groups with the plurality of bend-type phase shift circuits.

### EXPLANATION OF REFERENCES

1 Signal line
2 Inner line
3 Outer line
4a First ground conductor
4b Second ground conductor
7a First electronic switch
7b Second electronic switch
10, 10-5, 10-6, 10-7 Digital phase shift circuit
20, 20a, 20b Bend-type phase shift circuit
30 First digital phase shift circuit group
31 Second digital phase shift circuit group
41 Signal line
42 Inner line
43 Outer line
43a First outer line
43b Second outer line
44a First ground conductor
44b Second ground conductor
44c Third ground conductor
45 Capacitor
47a First electronic switch
47b Second electronic switch
100,200 Digital phase shifter
L1 First straight portion
L2 Second straight portion
L3 Third straight portion
L4 Fourth straight portion
L5 Fifth straight portion
L6 First oblique straight portion
L7 Second oblique straight portion

What is claimed is:

1. A bend-type phase shift circuit comprising:
a signal line;
an inner line provided on at least one side of the signal line;
an outer line provided at a position farther from the signal line than the inner line is, on at least one side of the signal line;
a first ground conductor electrically connected to one end of each of the inner line and the outer line;
a second ground conductor electrically connected to the other end of the outer line and not physically directly connected to the first ground conductor; and
an electronic switch provided between the other end of the inner line and the second ground conductor,
wherein the signal line, the inner line, and the outer line are bent, and
the bend-type phase shift circuit is set to a low-delay mode in which the electronic switch is in a closed state or a high-delay mode in which the electronic switch is in an open state.

2. The bend-type phase shift circuit according to claim 1,
wherein the outer line includes one or two outer lines,
the one end of at least one of the one or two outer lines is electrically connected to the first ground conductor at a position separated from one end of the first ground conductor, and
the other end of the at least one of the one or two outer lines is electrically connected to the second ground conductor at a position separated from one end of the second ground conductor.

3. The bend-type phase shift circuit according to claim 1, further comprising:
a capacitor electrically connected between the signal line and at least one of the first ground conductor and the second ground conductor.

4. The bend-type phase shift circuit according to claim 1,
wherein the outer line includes a first outer line disposed on an inner bent side with respect to the signal line and the inner line.

5. The bend-type phase shift circuit according to claim 4, further comprising:
a third ground conductor located to overlap a center portion of the first outer line in a plan view and electrically connected to the center portion of the first outer line; and
a capacitor electrically connected between the center portion of the signal line and the third ground conductor.

6. The bend-type phase shift circuit according to claim 4,
wherein the outer line further includes a second outer line disposed on an outer bent side with respect to the signal line and the inner line.

7. The bend-type phase shift circuit according to claim 6,
wherein the first ground conductor and the second ground conductor are strip-shaped conductors disposed such that extended lines therefrom intersect each other.

8. The bend-type phase shift circuit according to claim 7,
wherein the signal line and the inner line each include a first straight portion extending in a first direction intersecting the first ground conductor, a second straight portion extending in an oblique direction with respect to the first direction, and a third straight portion extending in a second direction intersecting the second ground conductor.

9. The bend-type phase shift circuit according to claim 8,
wherein the first outer line includes a fourth straight portion extending in the first direction and a fifth straight portion extending in the second direction.

10. The bend-type phase shift circuit according to claim 9,
wherein the first outer line includes a first oblique straight portion extending in the oblique direction, in addition to the fourth straight portion and the fifth straight portion, and
a length of the first oblique straight portion is longer than lengths of the fourth straight portion and the fifth straight portion.

11. The bend-type phase shift circuit according to claim 8,
wherein the second outer line includes a second oblique straight portion extending in the oblique direction, and
a length of the second oblique straight portion is longer than lengths of the first straight portion and the second straight portion of each of the signal line and the inner line.

12. The bend-type phase shift circuit according to claim 8,
wherein a length of the second straight portion of the signal line is longer than lengths of the first straight portion and the third straight portion of the signal line, and
a length of the second straight portion of the inner line is longer than lengths of the first straight portion and the third straight portion of the inner line.

13. A digital phase shifter comprising:
a first digital phase shift circuit group in which a plurality of digital phase shift circuits are cascade-connected;
a second digital phase shift circuit group in which a plurality of digital phase shift circuits are cascade-connected; and
the bend-type phase shift circuit according to claim 1, which is configured to electrically connect a first digital phase shift circuit located at one end portion of the first digital phase shift circuit group, and a second digital phase shift circuit located at one end portion of the second digital phase shift circuit group.

14. A digital phase shifter comprising:
a first digital phase shift circuit group in which a plurality of digital phase shift circuits are cascade-connected;
a second digital phase shift circuit group in which a plurality of digital phase shift circuits are cascade-connected;
a third digital phase shift circuit electrically connected to a first digital phase shift circuit located at one end portion of the first digital phase shift circuit group and a second digital phase shift circuit located at one end portion of the second digital phase shift circuit group;
a first bend-type phase shift circuit that is the bend-type phase shift circuit according to claim 1, which is configured to connect the first digital phase shift circuit and the third digital phase shift circuit; and
a second bend-type phase shift circuit that is the bend-type phase shift circuit according to claim 1, which is configured to connect the second digital phase shift circuit and the third digital phase shift circuit.

15. The digital phase shifter according to claim 13,
wherein each of the plurality of digital phase shift circuits forming the first digital phase shift circuit group and the plurality of digital phase shift circuits forming the second digital phase shift circuit group is a circuit that includes a signal line, a pair of inner lines provided on both sides of the signal line, a pair of outer lines provided on outer sides of the pair of inner lines, a first ground conductor electrically connected to one end of each of the pair of inner lines and the pair of outer lines, a second ground conductor electrically connected to the other end of each of the pair of outer lines, and a pair of electronic switches respectively provided between the other ends of the pair of inner lines and the second ground conductor, and that are set to a low-delay mode in which the pair of electronic switches are in a closed state or a high-delay mode in which the pair of electronic switches are in an open state.

16. The digital phase shifter according to claim 14,
wherein each of the plurality of digital phase shift circuits forming the first digital phase shift circuit group, the plurality of digital phase shift circuits forming the second digital phase shift circuit group, and the third digital phase shift circuit is a circuit that includes a signal line, a pair of inner lines provided on both sides of the signal line, a pair of outer lines provided on outer sides of the pair of inner lines, a first ground
conductor electrically connected to one end of each of the pair of inner lines and the pair of outer lines, a second ground conductor electrically connected to the other end of each of the pair of outer lines, and a pair of electronic switches respectively provided between the other ends of the pair of inner lines and the second ground conductor, and that are set to a low-delay mode in which the pair of electronic switches are in a closed state or a high-delay mode in which the pair of electronic switches are in an open state.
